(19) United States
(12) Patent Application Publication
(10) Pub. No.: US 2026/0038336 A1
(43) Pub. Date: Feb. 5, 2026

(54) SYSTEM AND METHOD FOR IMPLEMENTING INDIRECT ELECTRONIC TRANSFERS OF FUNDS TO GAMING MACHINES

(71) Applicant: Everi Payments Inc., Austin, TX (US)

(72) Inventors: Victor Newsom, Las Vegas, NV (US); Landon Scott Stansfield, Brainerd, MN (US); Tiffany Ranee Mayden, Las Vegas, NV (US); Rowan Elizabeth MacDonald, Murfreesboro, TN (US)

(21) Appl. No.: 19/283,717

(22) Filed: Jul. 29, 2025

Related U.S. Application Data
(60) Provisional application No. 63/677,156, filed on Jul. 30, 2024.

(51) Int. Cl. G07F 17/32

(52) U.S. Cl. CPC G07F 17/3244

(57) ABSTRACT

A method and system are provided for electronically associating funds with a gaming machine. A request for a transaction amount is received from a mobile device of a player and is used to generate a virtual monetary value ticket which is transmitted to a controller of a media reader associated with the gaming machine, which virtual ticket, when redeemed, results in the association of monetary value with a credit balance at the gaming machine.

### RELATED APPLICATION DATA

This application claims priority to U.S. Provisional Application Ser. No. 63/677,156, filed Jul. 30, 2024, which application is incorporated by reference herein in its entirety.

### FIELD OF THE INVENTION

The present invention relates to gaming machines, and particularly gaming machines which are configured to present wager-based games and events.

### BACKGROUND OF THE INVENTION

One age-old problem with casino gaming is the difficulty that players often have trying to access and associate funds with a gaming machine. Early machines required a player to insert coins to place wagers to play games, thus requiring the player to bring coins to the casino or use a cashier to turn currency into coins. Later, bill validators were added to gaming machines, allowing a player to simply insert currency to generate a credit balance at the gaming machine from which wagers could be placed.

This latter solution, however, still requires a player to provide currency to the gaming machine. In this case, a player must bring currency to the casino, or might use an ATM or a casino cashier to access currency that they can then take to the gaming machine.

A variety of new methodologies have been proposed for associating funds with a gaming machine electronically, such as where the funds are transferred from a bank card to the gaming machine or the like. Current solutions all suffer from a number of problems. For example, one solution is to send electronic funds through a casino management system to a gaming machine. One problem with this configuration is that there are many different casino management systems and even attempting to integrate with those systems is extremely complex.

A simple method for electronically transferring player funds to a gaming machine is desired.

### SUMMARY OF THE INVENTION

Embodiments of the invention include, but are not limited to, methods and systems for electronically associating funds with a gaming machine, preferably in an indirect manner. In one embodiment of a method and system, a request by a player to associate funds with a gaming machine results in the generation of a virtual monetary value ticket which is provided to a controller of a media reader thereof, which is then used by a controller of the gaming machine to validate the ticket and associate monetary value credits with a credit balance of the gaming machine.

In one embodiment of the invention, a method of electronically associating funds with a gaming machine having a media reader having a controller, comprises the steps of: receiving, at a financial server via a communication link with a mobile device of a player, gaming machine identification information, player identification information and a monetary transaction amount; verifying, by the financial server, available funds associated with the player in the monetary transaction amount; transmitting, to a ticketing server, a request for a monetary value ticket in the transaction amount; receiving, at the financial server, information identifying the monetary value ticket; and utilizing the gaming machine identification information to transmit, from the financial server to the controller of the media reader of the gaming machine, the information identifying the monetary value ticket for redemption and crediting of the monetary transaction amount to a credit balance at the gaming machine.

In another embodiment of a method, the information identifying the monetary value ticket is instead transmitted to the player's mobile device which, in turn via a communication link with the media reader, transmits that information to the media reader for use in validating the monetary value ticket and crediting the monetary transaction amount to the gaming machine.

In another embodiment of the invention, a gaming system comprises: a gaming machine, said gaming machine comprising a controller, a game display device, at least one player input device, and a media reader, the media reader comprising a controller and a reader configured to read physical monetary value tickets; a financial server comprising a processor, at least one data storage element and machine-readable code stored by the at least one data storage element and executable by the processor; wherein the machine-readable code of the financial server is configured cause the processor thereof to receive, via a communication link with a mobile device of a player, gaming machine identification information, player identification information and a monetary transaction amount, to verify available funds associated with the player in the monetary transaction amount, to transmit, to a ticketing server, a request for a monetary value ticket in the transaction amount, to receive information identifying the monetary value ticket, and to transmit, to the controller of the media reader of the gaming machine identified by the gaming machine identification information, the information identifying the monetary value ticket for redemption by the gaming machine and crediting of the monetary transaction amount to a credit balance at the gaming machine.

In another embodiment of a system, the machine-readable code of the financial server is configured to transmit the information identifying the monetary value ticket to the player's mobile device which, in turn, is configured to transmit that information to the controller of the media reader for use in validating the monetary value ticket and crediting the monetary transaction amount to the gaming machine.

Further objects, features, and advantages of the present invention over the prior art will become apparent from the detailed description of the drawings which follows, when considered with the attached figures.

### DESCRIPTION OF THE DRAWINGS

FIG. 1 is a diagram of a system in accordance with an embodiment of the invention;

FIG. 2 illustrates a gaming machine in accordance with an embodiment of the invention; and

FIG. 3 is a diagram of another system in accordance with another embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention include, but are not limited to, methods and systems for electronically associating monetary value funds with a gaming machine, such as for placing wagers to play wagering games.

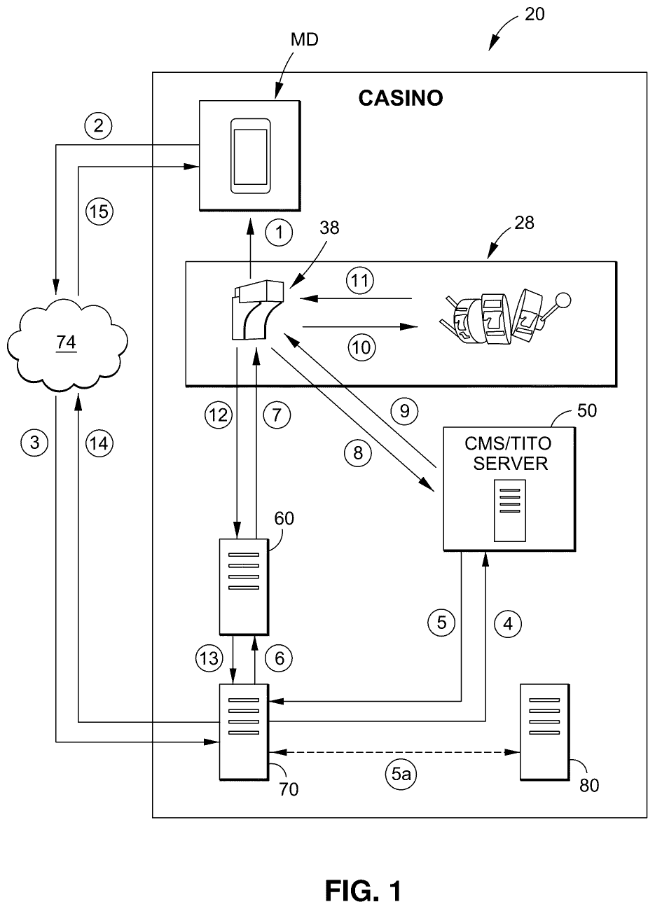

FIG. 1 illustrates one embodiment of the invention, which comprises a system 20. The system 20 may be referred to as a gaming system. Portions of the system might belong to or be operated by a casino (or the owner thereof) or entities other than a casino, and might be on-site or off-site as to the casino.

The gaming system 20 may comprise one or more devices and/or systems and may be associated with one or more physical locations. In one embodiment, the gaming system 20 includes one or more physical gaming devices 28, such as located on the floor of a casino.

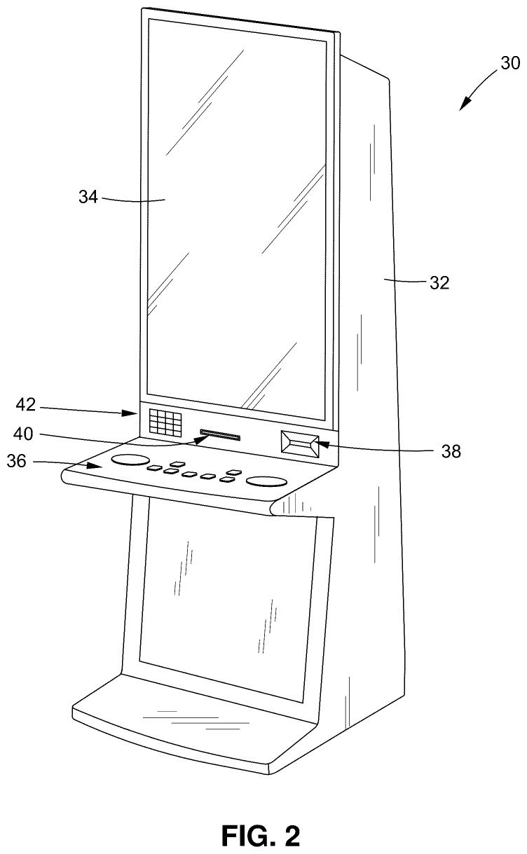

One embodiment of a gaming device 28 is illustrated in more detail in FIG. 2, wherein the gaming device comprises a gaming machine 30. As illustrated, the gaming machine 30 generally comprises a housing or cabinet 32 for supporting and/or enclosing various components required for operation of the gaming machine. The housing 32 may include one or more doors or access panels located at a front thereof, such as being configured to move between an open position which allows access to the interior, and a closed position in which access to the interior is generally prevented. The configuration of the gaming machine 30 may vary. In the embodiment illustrated, the gaming machine 30 has an “upright” configuration. However, the gaming machine 30 could have other configurations, shapes or dimensions (such as being of a “slant”-type, “bar-top” or other configuration as is well known to those of skill in the art).

The gaming machine 30 preferably includes at least one display device 34 configured to display game information. The display device 34 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 34 may be capable of projecting or displaying a wide variety of information, including images, symbols and other indicia or information associated with game play, game promotion or other events. The gaming machine 30 might include more than one display device 34, such as two or more displays which are associated with the housing 32. The gaming machine 30 might also include a top box or other portion. Such a top box might include one or more display devices, such as in addition to one or more main displays which are associated with the housing 32. Also, the gaming machine 30 might include side displays (such as mounted to the exterior of the housing 32) and might include multiple displays of differing sizes.

While the display devices may comprise one or more video displays, (such as for presenting video poker, video slots or other video-based games) in another embodiment, the gaming machine 30 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 30 is preferably configured to present one or more games upon a player making a monetary payment or wager. In this regard, as described in more detail below, the gaming machine 30 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 30 preferably includes a mechanism or means for returning unused monetary funds and/or dispensing winnings to a player.

The gaming machine 30 preferably includes one or more player input devices 36 (such as input buttons, plunger mechanisms, a touch-screen display, joystick, touch-pad or the like). These one or more devices 36 may be utilized by the player to facilitate game play, such as by providing input or instruction to the gaming machine 30. For example, such input devices 36 may be utilized by a player to place a wager, cause the gaming machine 30 to initiate a game, to indicate game inputs, to “cash out” of the gaming machine, or to provide various other inputs.

In one preferred embodiment, the gaming machine 30 includes at least one microprocessor or controller for controlling the gaming machine, including receiving player input and sending output signals for controlling the various components or peripheral devices of the machine 30 (such as generating game information for display by the display 34). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 34 (such as information comprising slot symbols, cards, etc.), and for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 30 may also include one or more random number generators for generating random numbers (such as implemented by a random number generator software module stored in the memory and executable by the processor or controller), such as for use in selecting slot symbols, cards or other game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine may be specially configured to present a game via specific software and/or hardware which causes the gaming machine to operate uniquely. For example, the controller of the gaming machine 30 may be configured to detect a wager, such as a signal from a player's depression of the “bet one” button (such as one of the buttons 36). Upon such an event and/or the player otherwise signaling the gaming machine to present the game, the controller may be configured to cause the at least one display 34 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 30. As indicated above, the machine readable code may be configured in various manners, such as by having various “modules” of software which are designed to implement specific features of the game play or game presentation.

The gaming machine 30 may be configured to generate and present games in a stand-alone manner or it may be in communication with one or more external devices at one or more times. For example, the gaming machine 30 may be configured as a server based device and obtain game code or game outcome information from a remote game server (in which event the gaming machine controller may receive game information from the server, such as game outcome information, and use that server-generated information to present the game at the gaming machine). For example, the gaming machine 30 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

As indicated, the gaming machine 30 is configured to present one or more wagering games. The gaming machine 30 is preferably configured to accept value, such as in the form of coins, tokens, paper currency or other elements or devices representing value such as monetary funds. Thus, as indicated above, the gaming machine 30 preferably includes a mechanism or means for accepting monetary value.

In one configuration, the gaming machine 30 includes a media reader 38. Such a reader may comprise a controller, a media reading device (such as a light scanner) and at least one communication interface which permits the media reader 38 to communicate with the controller of the gaming machine 30 (and as detailed below, that interface may also permit communications with at least one external system or server, directly or via other elements of the gaming machine, such as a slot machine interface board or SMIB). The media reader 38 may be configured to accept and read/verify paper currency and/or other media such as monetary value tickets or vouchers. Of course, in such event the gaming machine 30 may further be configured with one or more paper currency or ticket storage devices, such as cash boxes, and other paper currency or media handling devices (including transport devices).

When the player associates funds with the gaming machine or an associated system, a credit balance is generated. For example, when a player inserts currency into the media reader 38, the media reader 38 transmits information to a controller of the gaming machine 30 regarding an amount of the currency, which the gaming machine 30 uses to create or increase a credit balance (which credit balance may be tracked by one or more meters of the gaming machine). In the event the player inputs a monetary value ticket (described in more detail below) to the media reader 38, the media reader 38 may provide information regarding the ticket (such as a ticket serial number) to the controller of the gaming machine 30 which then sends the ticket information to an accounting or ticketing server 50 (see FIG. 1) for validation. If the ticket is valid, the amount of the ticket is then credited to the credit meter of the gaming machine.

The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 30 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 30 to indicate their desire to cash out, such as by selecting a “cash out” button (such as implemented via one of the buttons 36) or touch screen feature or providing other input. In response, a monetary value represented by the player's credit balance or the like is preferably paid, transferred or otherwise provided to the player. For example, upon an award or at cash-out, funds may be issued by dispensing paper currency or other media. In yet another embodiment, a player may be issued a media, such as a printed ticket, which ticket represents the value which was paid or cashed out of the machine. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 30 may also include a player tracking device, such as a card reader 40 and associated keypad 42. Such player tracking devices are well known and may permit the game operator to track the game play of players of the gaming machine. The tracked play may be utilized to offer player bonuses or awards. Of course, various means may be used for obtaining information which identifies a player (player tracking card, PIN number, ID number, bar code scan, biometric information, etc.), which information may be used to identify the player of the gaming machine, such as relative to data or other information which is associated with the player, such as at the system 20, financial server 70 or the like.

A casino may have numerous such gaming machines 30, such as located on a casino floor or in other locations. It will be appreciated that the gaming machine illustrated in FIG. 2 is only exemplary of one embodiment of a gaming machine. For example, it is possible for the gaming machine to have various other configurations, including different shapes and styles and having different components than as just described. Further, the gaming device 28 of the gaming system 20 might comprise other devices, such as table games.

Referring again to FIG. 1, the gaming system 20 may include one or more system servers, such as the accounting/ticketing server 50, a media reader server 60, a financial server 70 and a reporting server 80. Such system servers preferably comprise computing devices which comprise at least one processor for receiving information, processing information or executing code or software, and generating an output, such as control instructions.

In one embodiment, each system server 50, 60, 70, 80 includes means for storing information or instructions. Such means may comprise one or more memory devices. Such might comprise RAM, ROM (including EPROM, EEPROM, PROM) or other devices now known or later developed. In one embodiment, the servers may comprise or be in communication with one or more mass data storage devices, such as one or more hard drives or the like.

The system servers 50, 60, 70, 80 preferably also include at least one communication interface, by which it may receive and transmit information. The communication interface(s) may permit communications in accordance with various protocols (TCP/IP, 802.11xx, etc.) and in various forms and over various types of links (wired and/or wireless).

Each system server 50, 60, 70, 80 might actually comprise a system or network of a plurality of elements or devices. For example, each server might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the server, such as to change operator settings and the like. The system servers 50, 60, 70, 80 might also comprise a router and one or more separate computing devices. The functions of the various computing devices might be segregated.

The one or more gaming devices 28 are preferably in communication with the one or more system servers 50, 60, 70 at one or more times. For example, the gaming devices 28 and the one or more system servers 50, 60, 70, 80 (and the system servers themselves) may be linked via one or more communication links. These communication links may be wired and/or wireless and may be dedicated, shared, part of a LAN, WAN or other network, such as an internal casino network.

In one embodiment, the gaming devices 28 may communicate with the accounting/ticketing server 50, such as when seeking to print a monetary value ticket upon a cash-out request of a player (such as to create a ticket record and associated amount). For example, upon receiving a cash-out request from a player, a controller of the gaming device 28 may send, such as via a slot accounting system (“SAS”) communication port or interface, a request to the accounting/ticketing server 50 for the creation of a monetary value ticket in the amount of the funds associated with the credit balance at the gaming machine.

Likewise, when a player seeks to redeem a monetary value ticket at the gaming machine, such as by presentation of a monetary value ticket to the media reader 38, the media reader 38 may transmit information to the accounting/ticket server 50 for use by the accounting/ticketing server 50 in validating the ticket and the amount of funds associated therewith. Upon validation, the media reader 38 may signal the controller of the gaming machine 30 with information regarding the amount of funds to be credited to the credit balance of the gaming machine. The accounting/ticketing server 50 may, for example, generate and maintain records of monetary value tickets, including their amounts, whether they have been cashed-out, etc., and/or may perform other functionality, such as accounting functionality (tracking and reconciling monetary value provided to the gaming devices 28, amounts wager, amounts won, amounts cash-out, etc.).

Additional aspects of the gaming system 20 (including the configuration of machine-readable code or “software” which is executable by the processors of the various devices of the system 20) will be appreciated from examples of use thereof as described below.

One example of a method of the invention will now be described with reference primarily to FIG. 1. One aspect of the invention comprises a method of electronically associating monetary value with a gaming device.

In one embodiment of a method, a player may utilize their mobile device MD to initiate a request for the transfer of monetary funds to the gaming device 28 that they wish to play (or are playing). The player's mobile device MD may comprise a variety of existing or later developed devices that generally include a controller, a memory, a display, one or more player input devices, and a communication interface (such may comprise, for example, an Apple™ iPhone™ or similar devices manufactured and sold by other entities, as well as tablets, PDAs and similar devices).

In one embodiment, the player may use a financial application (such as provided by the casino, the financial provider or the like) in order to initiate the funds access and transfer process. For example, the player may download a funds access, wallet or other financial application to the memory of their mobile device MD (such as from an application server) for storage in a memory thereof and execution by the controller or processor thereof. This application preferably enables the functionality described below.

Referring to FIG. 1, in a step S1, the player may open/run the downloaded/installed financial application on their mobile device MD. The financial application may cause the controller of the mobile device MD to cause a video display thereof to display a graphical user interface of information. This information may comprise, for example, instructions and prompts. One prompt may be for the player to indicate a desired monetary transaction amount. The transaction amount might be selected from a preset amounts or might be input by the player.

The interface may then instruct a player to utilize a reader of their mobile device MD to read a secure token which is provided by or associated with the media reader 38. The particular reader which the player utilizes may depend upon the token, and might comprise an image capture device in the case of a machine readable code (such as a barcode), and in a preferred configuration may comprise a wireless interface, such as for reading a Near Field Code (NFC) which is emitted by the media reader 38 (such as a tag associated therewith), or other means, such as a Bluetooth™ communication connection as authorized by a provided authorization code. In other embodiments, the token might comprise a code which the player manually inputs (such as an alpha-numeric code). In a preferred embodiment, the token is system-usable to identify the particular gaming device associated therewith (such as where the token is linked to a unique gaming machine ID which identifies the gaming device).

In a step S2, the financial application preferably causes the player's mobile device MD to transmit (such as via the wireless communication interface thereof) the token, player information and monetary transaction amount, for processing, such as via one or more servers or platforms. In one embodiment, at least the player information and monetary transaction amount may be transmitted to a payment service 74. The payment service 74 may comprise one or more computing devices or other elements, including one or more servers and communication links. Such communication links may be associated with local area networks (LANs), wide area networks (WANs), the Internet, cellular networks, etc. In one example, the payment service 74 comprises one or more servers and at least one wireless communication network which allows information to be exchanged between the player's mobile device MD and the financial server 70 when the player is in the casino, such as via a server of the payment service 74. Such a server might, for example, be located remotely from the casino, such as at a location of a payment processor (such as which may support a wallet application and financial services functionality). In one embodiment, this payment service 74 may be a secure wireless communication network in order to prevent third party interception of the communications to and from the player's mobile device MD.

In a preferred embodiment, the financial application is linked to at least one player financial account and player identification information. The player identification information may comprise, for example, a player loyalty club ID, an account number, etc. The player financial account may comprise a variety of accounts (bank checking/savings accounts, credit card accounts, casino accounts, etc.), but in one embodiment, may comprise a wallet account, such as managed by the financial server 70. This wallet account may comprise, for example, an account which itself links to one or more financial accounts or sources, such as credit cards, bank accounts, etc.). Aspects of such a system are described in U.S. patent application Ser. No. 17/492,596, filed Oct. 2, 2021, the contents of which are incorporated herein by reference.

In a step S3, assuming verification of funds, the payment service 74 pushes/sends the token, player information and transaction amount to the financial server 70. In one embodiment, the financial server 70 might be located at the casino, but it could be located elsewhere.

In a step S4, the financial server 70 requests the accounting/ticketing server 50 to generate a monetary value ticket or voucher. In one embodiment, this comprises the financial server 70 using the player information to identify the player's financial account, such as their wallet account, and the existence of funds associated with that account (or otherwise accessible therefrom) in the transaction amount. If such funds exist or are accessible, then the financial server 70 may proceed with implementing the transaction. If not, the player might be notified that the transaction is declined, such as by a message from the financial server 70 back to the player's mobile device MD (such as via text, email or via the application running on their mobile device).

In a step S5, when the accounting/ticketing server 50 receives the request, it generates a monetary value ticket having the transaction value. As is known, this may comprise the accounting/ticketing server 50 generating a unique ticket ID and an associated ticket record regarding the ticket, including the ticket ID and the transaction amount. The accounting/ticketing server 50 then transmits information regarding the monetary value ticket back to the financial server 50 (such as the ticket ID and associated ticket value).

As illustrated in FIG. 1, in a step S5a, the financial server 50 may transmit the ticket information (such as ticket ID and ticket value) to the reporting server 80, such as for storage and associated reporting/auditing functions.

In a step S6, the financial server 70 sends the token and ticket information to the media reader server 60, such as via an application program interface (API) which links communications between the financial server 70 and the media reader server 60. As part of this step, the media reader server 60 may validate the token and/or ticket, such as to validate the authenticity/validity thereof.

In a step S7, the media reader server 60 transmits the ticket information to the media reader 38, such as via a communication link between the media reader server 60 and a communication interface of the media reader 38, which communication interface is associated with the controller of the media reader 38. The media reader server 60 preferably routes the ticket information utilizing the token, which preferably includes information which identifies the gaming device 28 and/or its media reader 38 (from other gaming devices and the media readers thereof).

Notably, in a common “TITO” situation, a player presents a physical ticket to the media reader 38 which reads information from the physical ticket and then provides that information to the controller of the gaming device 28. In this case, the ticket information which is provided to the media reader 38 is “virtual ticket information” in the sense that there is no associated physical ticket, thus bypassing the steps of issuing a physical ticket to the player and having the player present that physical ticket to the media reader.

In a step S8, in response to receiving the ticket information, the controller of the media reader 38 forwards the ticket information to the accounting/ticketing server 50 for validation (such as through a slot account system or “SAS” interface thereto or via the media reader server 60; depending on a configuration of the media reader 38 and the gaming device 28, the media reader 38 could forward the request via the controller of the gaming device 28, such as for routing through a SAS port of the gaming device 28 which is associated with the gaming device controller, to the accounting/ticketing server 50). Notably, this step is the same as that which would occur if the media reader 38 was seeking, via the gaming device 28, to validate a presented physical ticket.

In a step S9, the accounting/ticketing server 50 transmits the results of the validation back to the media reader 38. Of course, if the ticket is not validated, then the controller of the media reader 38 may be notified, thus preventing any monetary value from being credited thereby.

If a successful validation is indicated, in a step S10, the controller of the media reader 38 may notify the controller of the gaming device 28 to credit the monetary value ticket. This may comprise, for example, increasing a credit balance of funds at the gaming device 28 by the amount of the monetary value, including reflecting the credited amount on one or more meters of the gaming device 28.

In a step S11, the controller of the gaming device 28 preferably also transmits a confirmation to the media reader 38, which then forwards the response back to the media reader server 60, as in step S12. The media reader server 60 preferably then forwards the response to the financial server 70. In each case, information regarding the response may be stored and/or processed (such as by the media reader server 60, the financial server 70 and/or by reporting to the reporting server 80).

Most preferably, in a step S14, the response is also transmitted from the financial server 70 through the payment service 74 and thereon (such as in a step S15) to the player's mobile device MD. For example, this might cause the financial application running on the player's mobile device to indicate that the requested transaction has failed, or that the requested transaction was successfully completed and that the requested value has been credited to the designated gaming device 28.

Of course, when the transaction is successful, the requested funds which were associated with the gaming device 28 are deducted from the player account from which they were accessed. This might comprising a reduction in funds from an associated casino deposit account, a player's bank account, a credit card charge, etc., such as effectuated by the payment service 74.

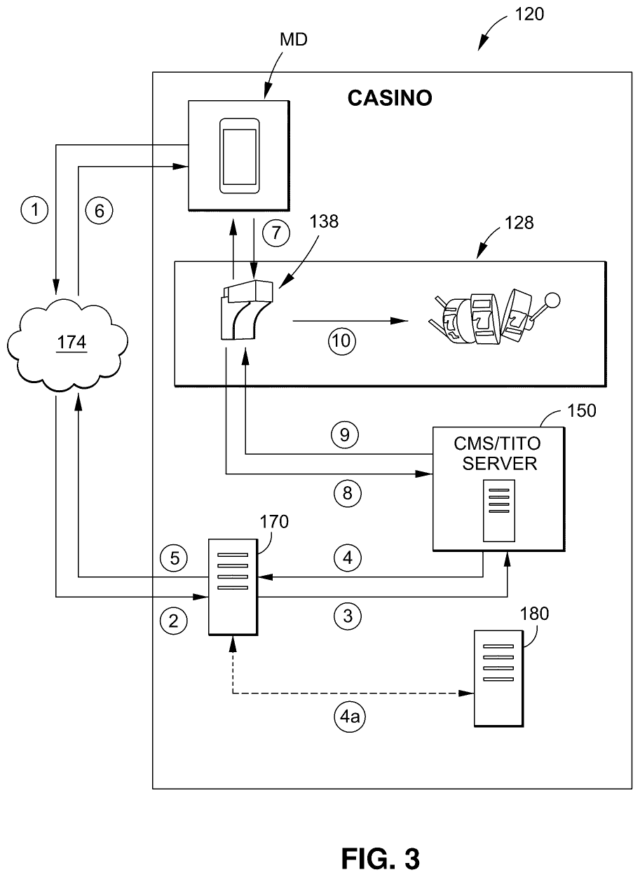

Another embodiment of a system 120 of the invention will be described with reference to FIG. 3. In this diagram, like reference numbers have been used to designate like elements to the system 20 illustrated in FIG. 1, except that they are identified with a “100” series designator.

This system 120 is similar to that illustrated in FIG. 1. In the embodiment illustrated in FIG. 1, however, the system 20 is configured so that the media reader 38 communicates with a media reader server 60 in order to enable at least some of the described functionality. This requires that the media reader 38 be communicatively coupled to the media reader server 60, such as via an Ethernet or other communication cable. In many environments, such a configuration is cost or time prohibitive to implement, as it may require retrofitting a casino, tavern or other location, with the appropriate cabling to effectuate the communication coupling. In the case of a casino having hundreds if not thousands of gaming machines across its floor, this can require removing flooring and installing new cabling between a back room and each gaming machine, all at tremendous time and cost.

FIG. 3 illustrates an embodiment of the invention which does not require communicative coupling between the media reader and a media reader server. This system 120 may again include a plurality of gaming devices 128 each having at least one associated media reader 138, where those gaming devices 128 are communicatively coupled to a accounting/ticketing server 150. The system 120 may again also include a financial server 170 and a reporting server 180.

Additional details of the system 120 will be appreciated from a description of one method of electronically associating monetary value with a gaming device.

One again, a player may once again open/run the downloaded/installed financial application on their mobile device MD. The financial application may cause the controller of the mobile device MD to cause a video display thereof to display a graphical user interface of information. This information may comprise, for example, instructions and prompts. One prompt may be for the player to indicate a desired transaction amount. The transaction amount might be selected from a preset amounts or might be input by the player.

The interface may then instruct a player to utilize a reader of their mobile device MD to read a secure token which is provided by or associated with the media reader 138. The particular reader which the player utilizes may depend upon the token, and might comprise an image capture device in the case of a machine readable code (such as a barcode), and in a preferred configuration may comprise a wireless interface, such as for reading a Near Field Code (NFC) which is emitted by the media reader 138 (such as a tag associated therewith), or other means, such as a Bluetooth™ communication connection as authorized by a provided authorization code. In other embodiments, the token might comprise a code which the player manually inputs (such as an alpha-numeric code). In a preferred embodiment, the token is system-usable to identify the particular gaming device associated therewith (such as where the token is linked to a unique gaming machine ID which identifies the gaming device).

In a step S1, the staged or requested transaction (including the token and amount of the desired transaction) may be transmitted to a payment service 174. In one embodiment, the requested transaction is transmitted (via the financial application running on the player's mobile device MD causing the processor thereof to send a signal from a communication interface thereof) from the player's mobile device MD over a network or other communication link to the payment service 174. This request may be transmitted, for example, via the cellular network connection of the player's mobile device MD to the payment service 174, or via other networks.

In one embodiment, the payment service 174 preferably receives the request and processes it in order to generate a request to the financial server 170 for a monetary value ticket in the value of the requested transaction. This may include receiving information about the player and/or their wallet account and the requested transaction in order to validate that the player has the funds necessary for the transaction associated with their account (such as on deposit or available via a funding source, such as a credit card, etc.). Once any validation/pre-processing is completed, the processing preferably comprises the payment service 174 transmitting the request to the financial server 170 (if, for example, the payment service 174 determines that the player has insufficient funds for the desired transaction, the request may be terminated and the player may be notified of such, such as via a message displayed on their mobile device MD by the application), such as at step S2.

In a step S3, the financial server 170 preferably processes and forwards or transmits a corresponding request for the monetary value ticket to the accounting/ticketing server 150 for a monetary value ticket in the value of the requested transaction.

The accounting/ticketing server 150 preferably then generates information regarding a monetary value ticket. This may comprise, as is known in the art and as described above, a ticket record which includes information about the request, including the amount, as well as a ticket ID, transaction regard and the like. The accounting/ticketing server 150 preferably also generates a machine-readable code such as a barcode, which code identifies the ticket, the amount of the ticket, etc.

In a step S4, ticket information, such as the barcode, is transmitted from the ticketing/accounting server 150 back to the financial server 170. In a step S4a, the financial server 170 may transmit information regarding the requested transaction, information regarding the ticket, etc., to a reporting server 180.

In a step S5, the financial server 170 decodes the barcode to identify the associated ticket information, such as the ticket ID and amount of the ticket. This ticket information is forwarded from the financial server 170, such as via the payment service 174, to the player's mobile device MD via the financial application running thereon, as at step S6. The player's mobile device MD, via the financial application running thereon, then transmits the ticket information to the media reader 138, such as via the communication link therewith, as at step S7.

In a step S8, the media reader 138 uses the provided monetary value ticket information to request a ticket validation from the ticketing/accounting server 150. In step S9, the ticketing/accounting server 150 returns a validation response. If the monetary value ticket is not validated, then the transaction is rejected. If it is, then in a step S10, the media reader 138 instructs the processor of the gaming machine to credit the value of the monetary value ticket. This may comprise crediting the value of the monetary value ticket to a primary credit meter. The media reader 138 and/or an associated system may then report the crediting of the monetary value ticket to the gaming machine to the ticketing/accounting system 150 for updating the associated ticket record. As with the prior embodiment, in this embodiment of the invention, the monetary value ticket which is used as the vehicle to associate funds with the gaming machine is virtual, in the sense that it is defined by electronic data and does not comprise a physical ticket (such as a printed paper ticket).

It will not be appreciated that in this embodiment, instead of monetary value ticket information being provided to the media reader 138 through an associated system and a communication link to that system, the monetary value ticket information is provided to the media reader 138 via the player's own mobile device MD.

As with the prior embodiment, when a monetary value ticket is successfully generated in response to a player's request, their wallet, or one or more accounts associated therewith, are preferably updated to reflect the association of the monetary value from the wallet/account to the monetary value ticket, such as by deducting the amount thereof from the wallet/account. Further, when the monetary value/funds are moved from a player's account to a monetary value ticket via a third party processor, such as by the third party processor transferring funds to the casino for the monetary value ticket, those funds are preferably transferred from the player's wallet or other account, to the third party processor. This may occur, for example, in a banking network in which the funds are transferred from the player's bank or credit card account to a bank account of the third party processor.

In one or more embodiments, transaction or other fees may be applied, such as by being charged or deducted, relative to the transaction. For example, if a player desires a monetary transaction amount of $100, then $110 may be deducted from the player's wallet or an account associated therewith. In another embodiment, relative to such a desired monetary transaction, only $90 might be associated with a monetary value ticket even though $100 is deducted from the player's wallet or an associated account.

The invention has a number of advantages. One advantage is the ability of a player to electronically associate funds with a gaming device without the need for coins, cash or even a physical ticket. Another advantage is that the system and method permit a player to electronically associate funds with a gaming machine 28 from a number of different sources, such as a casino account, a bank account, a credit card or various other financial accounts, including in one embodiment by a wallet. Yet another advantage of the invention is a system and method by which a virtual ticket is used to associate funds with a gaming machine. The use of a virtual ticket avoids a number of issues associated with the use of physical tickets, including the cost of printing the ticket, collection of presented tickets (such as from collection boxes associated with the gaming devices) and issues associated with a player's failure to redeem a physical monetary value ticket within a designated period of time.

In this regard, in one embodiment of the invention, if the redemption of a virtual ticket is unsuccessful, such as due to a communication error or other issue which prevents the gaming device from crediting the virtual ticket, the financial server 70, media reader server 60 may instruct the accounting/ticketing server 50 to void the ticket, thus preventing it from remaining outstanding in a suspended state.

While the invention has been described relative to a plurality of particular devices, such as servers, it will be appreciated that in some cases, functionality of different ones of those devices might be consolidated and performed by fewer devices.

In a situation where gaming devices of a casino already have media readers which are linked to a vendor's media reader server, the invention can be implemented relative to that existing infrastructure, such as by associating the financial server and payment service therewith. In other embodiments, a communication interface and associated controller might be associated with an existing gaming device media reader, thus allowing communications between the financial server and the media reader of the gaming device in order to permit the functionality herein.

As one aspect of the system, monetary value is associated with a gaming machine both without the use of a physical ticket and without the need for an image of the ticket. As indicated, information which identifies the ticket is simply generated and transmitted between elements of the system described above in a manner which does not require a physical ticket or an image of a ticket. Relative to the system 20 described with reference to FIG. 1, the information regarding the virtual monetary value ticket or voucher isn't even provided to the player's mobile device. Relative to the system 120 described with reference to FIG. 3, the information regarding the virtual monetary value ticket may simply be provided to the controller of the player's mobile device and transmitted thereon to the media reader, without it being visible to the player (for example, without an image of the monetary value ticket being generated or displayed to the player, such as via the display thereof), thus increasing the security of the system.

For example, in accordance with the invention, information which identifies a ticket may be provided to the player's wallet application in a human non-readable form, and that information may be provided by the player's mobile device to the media reader, including in the form of a secure token or the like. In this configuration, in the event the player's funds transaction ultimately fails or the ticket otherwise needs to be canceled, this can be accomplished at the ticketing server, whereupon the ticket information or token simply fails to link to or identify a valid ticket (in contrast to a configuration where an image of a ticket is provided to a player, which image once stored on a player device, can't be recalled).

The configuration of the present invention may comprise one of multiple different payment processing options and funds transfer mechanisms that may be part of a larger or integrated financial ecosystem, such as Everi Payment's BeOn Pay system. Further details of aspects of such an ecosystem are described in US Patent Application Publication US 2022/0147957, which is co-owned by the Applicant hereof, and which is incorporated by reference in its entirety herein.

As described in the '957 Publication, the ecosystem may comprise a financial processing architecture and one or more transport layers or interfaces between that financial processing architecture and other elements. As described, those other elements may comprise various touch-points such as kiosks and gaming machines.

As described in the '957 Publication, as one aspect of such an ecosystem, the financial processing architecture may enable patron exchanges which are linked to exchange accounts (64). A patron may associate funds with the exchange account (64), such as by transfer from their bank account. A patron may use their exchange to access their funds, such as from an access touch-point. Such a touch-point may include the patron's mobile device having an application running thereon, such as the financial application referenced herein. The patron may associate those funds with a gaming machine (24) or another device, such as for funding wagering game play. As indicated at [0075] of the '957 Publication, the patron's funds may be associated with a gaming machine (24) via a transport layer or interface, such as via a casino slot management system. The present invention represents another manner (e.g. an interface or transport layer) which may couple the financial processing architecture of the '957 Publication (or other such systems) to a touch point—e.g., by which the patron's funds may be associated with a gaming machine. As one aspect of the invention herein, funds may be associated with a gaming machine by a transport layer or interface other than use of a casino slot management system (which has particular advantages, such as where the gaming machines are not connected to such a system, where issues arise with interfacing with such a system, etc.).

It will be understood that the above-described arrangements of apparatus and the method therefrom are merely illustrative of applications of the principles of this invention and many other embodiments and modifications may be made without departing from the spirit and scope of the invention as defined in the claims.

What is claimed is:

1. A method of electronically associating funds with a gaming machine having a media reader having a controller, comprising the steps of:
receiving, at a financial server via a communication link with a mobile device of a player, gaming machine identification information, player identification information and information indicating a monetary transaction amount;
verifying, by said financial server, available funds associated with said player in said indicated monetary transaction amount;
transmitting, to a ticketing server, a request for creation of a monetary value ticket in said monetary transaction amount;
receiving, at said financial server, information identifying said created monetary value ticket; and
utilizing said gaming machine identification information to transmit, from said financial server to said controller of said media reader of said gaming machine, said information identifying said monetary value ticket for redemption and crediting of said monetary transaction amount to a credit balance at said gaming machine.

2. The method in accordance with claim 1, wherein said gaming machine identification information comprises a code which is input into or read by said mobile device of said player.

3. The method in accordance with claim 1, wherein said gaming machine identification information identifies said media reader of said gaming machine.

4. The method in accordance with claim 1, wherein said financial server transmits said information identifying said monetary value ticket to a media reader server for transmission to said media reader.

5. The method in accordance with claim 1, wherein said gaming machine identification information comprises a token.

6. The method in accordance with claim 1, wherein said financial server implements a payment platform configured to verify said available funds from a player account.

7. A gaming system comprising:
a gaming machine, said gaming machine comprising a controller, a game display device, at least one player input device, and a media reader, said media reader comprising a controller and a reader configured to read physical monetary value tickets;
a financial server comprising a processor, at least one data storage element and machine-readable code stored by said at least one data storage element and executable by said processor;
said machine-readable code of said financial server configured cause said processor thereof to:
receive, via a communication link with a mobile device of a player, gaming machine identification information, player identification information and a monetary transaction amount;
verify available funds associated with said player in said monetary transaction amount;
transmit, to a ticketing server, a request for a monetary value ticket in said monetary transaction amount;
receive information identifying said monetary value ticket; and
transmit, to said controller of said media reader of said gaming machine identified by said gaming machine identification information, said information identifying said monetary value ticket for use in redeeming said monetary value ticket and crediting said monetary transaction amount to a credit balance at said gaming machine.

8. The gaming system in accordance with claim 7, further comprising downloadable machine-readable code for storage on a memory of said mobile device of said player, said downloadable machine-readable code configured to cause a processor of said mobile device to receive said gaming machine identification information.

9. The gaming machine in accordance with claim 8, wherein said gaming machine identification information comprises a code read by a reader of said mobile device.

10. The gaming machine in accordance with claim 8, further comprising a media reader server comprising a processor, a memory and machine-readable code stored in said memory and executable by said processor of said media reader server to receive said gaming machine identification information and said information identifying said monetary value ticket from said financial server and utilize said gaming machine identification information to transmit said information identifying said monetary value ticket to said controller of said media reader.

11. The gaming machine in accordance with claim 10, wherein said information identifying said monetary value ticket comprises a barcode which identified a record corresponding to said ticket stored in association with said ticketing server.

13. A method of electronically associating funds with a gaming machine having a media reader having a controller, comprising the steps of:
receiving, at a financial server via a communication link with a mobile device of a player, gaming machine identification information, player identification information and a monetary transaction amount;
verifying, by said financial server, available funds associated with said player in an amount of said monetary transaction amount;
transmitting, to a ticketing server, a request for a monetary value ticket in said monetary transaction amount;
receiving, at said financial server, information identifying said monetary value ticket;
transmitting said information identifying said monetary value ticket to said mobile device of said player; and
utilizing said mobile device of said player to transmit said information identifying said monetary value ticket to said controller of said media reader of said gaming machine for redemption and crediting of said monetary transaction amount to a credit balance at said gaming machine.

14. The method in accordance with claim 13, wherein said gaming machine identification information comprises a token displayed by a display of said gaming machine and read by a reader of said mobile device.

15. The method in accordance with claim 13, wherein said financial server is associated with a payment processing platform which verifies said available funds from an associated player account.

16. The method in accordance with claim 13, wherein said mobile device transmits said information identifying said monetary value ticket to said controller of said media reader of said gaming machine via a wireless communication link with said media reader.

17. The method in accordance with claim 13, further comprising the step of transmitting, from said media reader to said ticketing server, a request for redemption of said monetary value ticket.

18. A gaming system comprising:
a gaming machine, said gaming machine comprising a controller, a game display device, at least one player input device, and a media reader, said media reader comprising a controller and a reader configured to read physical monetary value tickets;
a financial server comprising a processor, at least one data storage element and machine-readable code stored by said at least one data storage element and executable by said processor;
said machine-readable code of said financial server configured cause said processor thereof to:
receive, via a communication link with a mobile device of a player, gaming machine identification information, player identification information and a monetary transaction amount;
verify available funds associated with said player in said monetary transaction amount;
transmit, to a ticketing server, a request for a monetary value ticket in said monetary transaction amount;
receive information identifying said monetary value ticket; and
transmit, to said mobile device of said player, said information identifying said monetary value ticket for use by said mobile device of said player in transmitting said information identifying said monetary value ticket to a controller of said media reader for use in redeeming said monetary value ticket and crediting said monetary transaction amount to a credit balance at said gaming machine.

19. The gaming system in accordance with claim 18, wherein said mobile device transmits said information identifying said monetary value ticket to said controller of said media reader of said gaming machine via a wireless communication link with said media reader.
